(19) United States
(12) Patent Application Publication
(10) Pub. No.: US 2015/0117917 A1
(43) Pub. Date: Apr. 30, 2015

(54) PRINT MEDIUM SUPPORTING DEVICE AND IMAGE FORMING APPARATUS HAVING THE SAME

(71) Applicant: SAMSUNG ELECTRONICS CO., LTD., Suwon-si (KR)

(72) Inventors: Won-chul JUNG, Suwon-si (KR); Won-kook, Bucheon-si (KR); Byoung-chul BAE, Suwon-si (KR)

(73) Assignee: SAMSUNG ELECTRONICS CO., LTD., Suwon-si (KR)

(21) Appl. No.: 14/471,160

(22) Filed: Aug. 28, 2014

(30) Foreign Application Priority Data
Oct. 25, 2013 (KR) 10-2013-0127664

(51) Int. Cl. G03G 15/16

(52) U.S. Cl. CPC G03G 15/1615
USPC 399/316

(57) ABSTRACT

An image forming apparatus includes an image carrier on which a developer image is formed, a transfer roller disposed to be in contact with the image carrier to form a transfer nip and to transfer the developer image formed on the image carrier onto a print medium, a print medium guide member to guide the print medium that has passed through the transfer nip to a fixing unit, and a print medium supporting member rotatably disposed between the transfer roller and the print medium guide member, and comprising a first contacting portion to be in contact with the print medium that has passed through the transfer nip and a second contacting portion that, when the first contacting portion is rotated by the print medium, is rotated integrally with the first contacting portion so as to be in contact with a rear surface of the print medium.

### CROSS-REFERENCE TO RELATED APPLICATIONS

This application claims the benefit of priority under 35 U.S.C. §119 from Korean Patent Application No. 2013-0127664 filed Oct. 25, 2013 in the Korean Intellectual Property Office, the disclosure of which is incorporated herein by reference in its entirety.

### BACKGROUND OF THE INVENTION

1. Field of the Invention

The present general inventive concept relates to an electro-photographic image forming apparatus. More particularly, the present general inventive concept relates to an image forming apparatus that can prevent contamination of a rear end portion of a print medium that may occur due to a transfer roller.

2. Description of the Related Art

Electro-photographic image forming apparatuses, such as copy machines, printers, multifunctional products or the like, use a transfer member to move developer images that are formed on an image carrier during an image forming process onto a print medium. At this time, a transfer method includes a corona transfer method, a transfer roller method, etc. However, due to miniaturization and simplification of the apparatus, the ozone generating problem of the corona method, etc., the transfer roller method is mainly used.

In an image forming apparatus having a transfer roller and an image carrier facing the transfer roller, while a print medium is passing through between the transfer roller and the image carrier, a developer image is transferred onto the print medium, and then the print medium is moved to a fixing unit along a print medium guide member.

The print medium guide member between the transfer roller and the fixing unit causes the moving print medium to be curled (or looped). In a transfer process, the print medium is attached to the image carrier by an electrostatic force, and then is separated from the image carrier so that the print medium is curled in one direction. Accordingly, when the print medium that has passed the transfer roller passes through the print medium guide member, a restoring force to return the curled print medium to its original flat state is applied to the curled print medium. The restoring force varies depending on irregularities of resistance or thickness of the print medium, and a position in which the print medium is separated from the transfer roller delicately varies.

Further, as illustrated in FIG. 1, when the print medium P comes out of a transfer roller 20, the rear end portion of the print medium P collides with the transfer roller 20 by the restoring force of the print medium P. If the rear end portion of the print medium P collides with the transfer roller 20, the residual developer of the transfer roller 20 is attached to the print medium P so that contamination of the rear end portion of the print medium P occurs.

Particularly, when a duplex printing function is used, the curl and resistance value of the print medium P are increased so that contamination of the rear end portion of the print medium P is significantly increased.

In order to prevent contamination of the rear end portion of the print medium P, a print medium guide member 30 is disposed near the image carrier 11 to guide the print medium P that comes out of the transfer roller 20. However, if the print medium guide member 30 is disposed too close to the image carrier 11, when the leading end of the print medium P comes out of the transfer roller 20, the leading end of the print medium P does not safely get on the print medium guide member 30, and collides with the print medium guide member 30 so that paper jam may occur.

Contrarily, if the print medium guide member 30 is disposed away from the image carrier 11, the leading end of the print medium P may be securely seated on the print medium guide member 30. However, in this case, when the rear end portion of the print medium P comes out of the transfer roller 20, the rear end portion of the print medium P strongly collides with the transfer roller 20 by the curl that occurs during movement of the print medium P. Accordingly, contamination of the rear end portion of the print medium P occurs.

In order to improve this problem, the occurrence of the above-described problem should be suppressed by strictly managing the dimension of the print medium guide member. However, such strict dimensional management of components is disadvantageous to mass production.

In order to improve this, by detecting a degree of curl of a print medium between a transfer roller and a fixing unit using a curl sensor and by suppressing formation of excessive curl, a restoring force of the print medium may be decreased. Then, the force with which the rear end portion of the print medium collides with the transfer roller is decreased so that contamination of the rear end portion of the print medium may be reduced. However, this method has a problem in that development period and material cost are increased due to the complexity of the control.

### SUMMARY OF THE INVENTION

The present general inventive concept is directed to overcome the above drawbacks and other problems associated with the conventional arrangement. The present general inventive concept provides an image forming apparatus that can minimize and/or prevent contamination of a rear end portion of a print medium with decreased costs and decrease structural complexity.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an image forming apparatus, which may include an image carrier on which a developer image is formed, a transfer roller disposed to be in contact with the image carrier to form a transfer nip and to transfer the developer image formed on the image carrier onto a print medium, a print medium guide member to guide the print medium that has passed through the transfer nip to a fixing unit, and a print medium supporting member rotatably disposed between the transfer roller and the print medium guide member, and having a first contacting portion to be in contact with the print medium that has passed through the transfer nip and a second contacting portion that, when the first contacting portion is rotated by the print medium, is rotated integrally with the first contacting portion so as to be in contact with a rear surface of the print medium.

The print medium supporting member may include a rotation shaft that is rotatably disposed between the transfer roller and the print medium guide member, the first contacting portion may extend from the rotation shaft toward the print medium guide member, the second contacting portion may extend from the rotation shaft toward the transfer roller, and the second contacting portion may be disposed so as to not be in contact with the print medium until the print medium is in contact with the first contacting portion.

The first contacting portion of the print medium supporting member may intersect a tangent line passing through the transfer nip before the print medium is in contact with the first contacting portion of the print medium supporting member.

The second contacting portion of the print medium may not intersect the tangent line passing through the transfer nip.

The print medium supporting member may be disposed to move between a first position in which both the first contacting portion and the second contacting portion are not in contact with the print medium and a second position in which both the first contacting portion and the second contacting portion are in contact with the print medium.

When the print medium is not in contact with the print medium supporting member, the print medium supporting member may be placed in the first position.

The print medium supporting member may include a restoring member to return the print medium supporting member to the first position.

The restoring member may include a coil spring or a torsion spring.

The print medium supporting member may be formed so that a weight of the second contacting portion is heavier than a weight of the first contacting portion, and the print medium supporting member is returned to the first position by gravity.

The print medium supporting member may include at least two print medium supporting members.

The image carrier may be a photosensitive member.

The image carrier may be an intermediate transfer member.

The present general inventive concept may also provide an image forming apparatus including an image carrier on which a developer image is formed, a transfer roller disposed to be in contact with the image carrier to form a transfer nip and to transfer the developer image formed on the image carrier onto a print medium, a print medium guide member to guide the print medium that has passed through the transfer nip to a fixing unit, and a print medium supporting member disposed between the transfer roller and the print medium guide member, and to rotate between a first position and a second position, where the print medium supporting member may include a rotation shaft rotatably disposed between the transfer roller and the print medium guide member, a first contacting portion extending from the rotation shaft toward the print medium guide member, and a second contacting portion extending from the rotation shaft toward the transfer roller, when the print medium supporting member is placed in the first position, the first contacting portion may intersect a tangent line of the transfer nip, and the second contacting portion may not intersect the tangent line of the transfer nip, and, when the print medium supporting member is placed in the second position, the first contacting portion and the second contacting portion may be in contact with the print medium.

A leading end of the print medium that has passed through the transfer nip may be in contact with the first contacting portion of the print medium supporting member that is placed in the first position, and, as the print medium continues to move, the first contacting portion may be rotated so that the first contacting portion is in contact with the rear surface of the print medium and then the second contacting portion is in contact with the rear surface of the print medium.

The first and second contacting portions may be formed in a rectangular plate, and a length of the first contacting portion may be longer than or a same length as a length of the second contacting portion.

The second contacting portion may be positioned to not contact the print medium until the print medium is in contact with the first contacting portion.

The present general inventive concept may also provide a print medium supporting member to minimize and/or prevent a print medium that has exited a roller from impacting against the roller, having a rotation shaft, a first contacting portion mounted on the rotation shaft, and a second contacting portion mounted on the rotation shaft, where the print medium supporting member moves about the rotation shaft between a first position in which the first contacting portion supports the print medium and a second position in which both the first contacting portion and the second contacting portion support the print medium.

The first and second contacting portions may be mounted on the rotation shaft such that a leading edge of the print medium bypasses the second contacting portion and contacts the first contacting portion such that the print medium supporting member shifts from the first position to the second position.

The print medium supporting member may further include a restoring member to force the print medium supporting member into the first position when the print medium is not in contact with the print medium supporting member.

The second contacting portion may be disposed adjacent to the roller such that when the print medium supporting member is in the second position the second contacting portion minimizes and/or prevents a rear edge of the print medium from impacting against the roller after the printing medium has exited the roller.

The second contacting portion may be moved by a reciprocal force transferred from the first contacting portion and received via the rotating shaft.

Other features and utilities of the present general inventive concept will become apparent from the following detailed description, which, taken in conjunction with the annexed drawings, discloses preferred embodiments

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a partial cross-sectional view illustrating an image forming portion of a conventional image forming apparatus;

FIG. 2 is a partial cross-sectional view illustrating an image forming portion of an image forming apparatus according to an exemplary embodiment of the present general inventive concept;

FIG. 3 is a perspective view illustrating a print medium supporting member that is applied to an image forming apparatus according to an exemplary embodiment of the present general inventive concept;

FIG. 4 is a perspective view illustrating the print medium supporting member of FIG. 3 disposed between a transfer roller and a print medium guide member;

FIG. 5 is a view illustrating another print medium supporting member that is used to an image forming apparatus according to an exemplary embodiment of the present general inventive concept;

FIG. 6 is a view illustrating still other print medium supporting member that is used to an image forming apparatus according to an exemplary embodiment of the present general inventive concept;

FIGS. 7 to 9 are views illustrating an operation of a print medium supporting member in an image forming apparatus according to an exemplary embodiment of the present general inventive concept; and

FIG. 10 is a partial cross-sectional view schematically illustrating an image forming portion of an image forming apparatus according to another exemplary embodiment of the present general inventive concept.

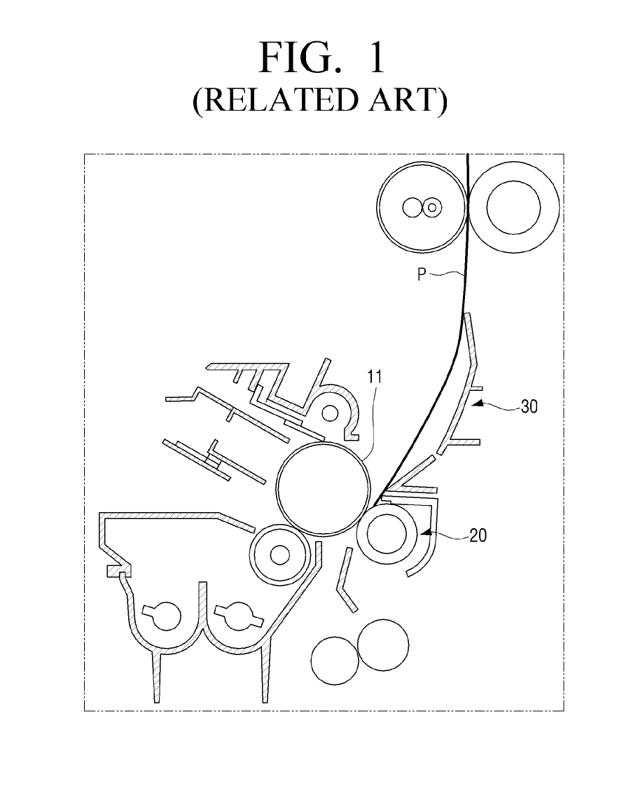

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

The matters defined herein, such as a detailed construction and elements thereof, are provided to assist in a comprehensive understanding of this description. Thus, it is apparent that exemplary embodiments may be carried out without those defined matters. Also, well-known functions or constructions are omitted to provide a clear and concise description of exemplary embodiments. Further, dimensions of various elements in the accompanying drawings may be arbitrarily increased or decreased for assisting in a comprehensive understanding.

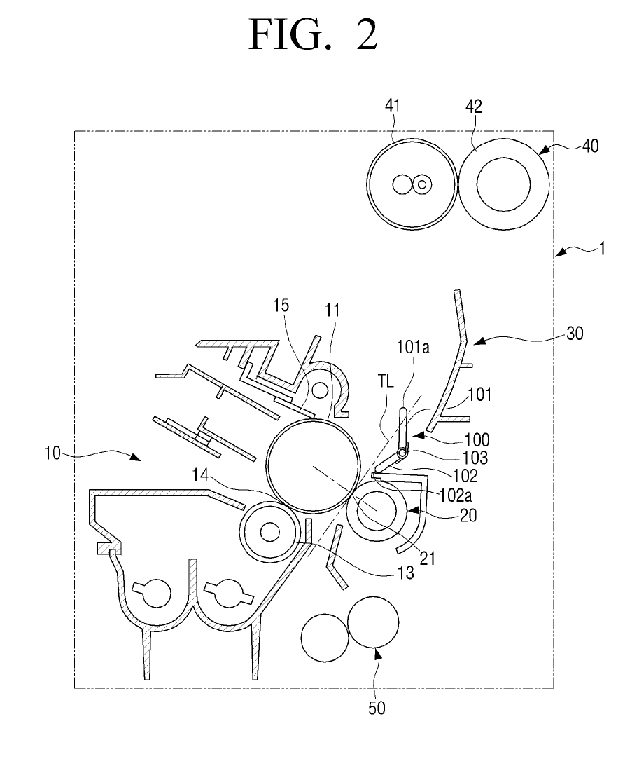

FIG. 2 illustrates a partial cross-sectional view of an image forming portion of an image forming apparatus according to an embodiment of the present general inventive concept.

Referring to FIG. 2, an image forming apparatus 1 according to an embodiment of the present general inventive concept may include an image forming unit 10, a print medium guide member 30, a fixing unit 40, and a print medium supporting member 100. Further, although not illustrated in FIG. 2, the image forming apparatus 1 further includes a print medium feeding unit to supply a print medium P and a discharging unit to discharge the print medium P, of which the image fixing is completed, out of the image forming apparatus 1. The print medium feeding unit and the discharging unit can use, for example, a conventional print medium feeding unit and discharging unit. Therefore, detailed descriptions thereof are omitted.

The image forming unit 10 is to form a developer image corresponding to printing data on a print medium P that is supplied from the print medium feeding unit, and may include an image carrier 11, a developing roller 13, a transfer roller 20, and a cleaning member 15. The developing roller 13, the transfer roller 20, and the cleaning member 15 are sequentially disposed around the image carrier 11.

An exposure unit (not illustrated) is disposed in or near a side of the image carrier 11, and the exposure unit emits light corresponding to the printing data. Electrostatic latent images corresponding to the printing data are formed on a surface of the image carrier 11 by the light emitted from the exposure unit. In a case of an embodiment as illustrated in FIG. 2, a photosensitive medium, namely, a photosensitive drum is used as the image carrier 11.

The developing roller 13 may be rotatably disposed closely to or in contact with the image carrier 11, and supplies developer to the image carrier 11. When the electrostatic latent image formed on the image carrier 11 passes through a developing nip 14 where the image carrier 11 and the developing roller 13 face each other, the electrostatic latent image is supplied with developer from the developing roller 13 so as to be converted into a developer image.

The transfer roller 20 is rotatably disposed in contact with the image carrier 11, and allows the developer image formed on the image carrier 11 to be moved onto the print medium P. An area where the transfer roller 20 is in contact with the image carrier 11 forms a transfer nip 21, and the print medium P to be supplied from the print medium feeding unit enters the transfer nip 21. A register roller 50 may be disposed in front of the transfer roller 20 in order to control the print medium P to enter the transfer nip 21.

The cleaning member 15 removes waste toner that is not transferred onto the print medium P in the transfer nip 21 and that remains on the image carrier 11.

The print medium guide member 30 guides the print medium P that has passed through the transfer nip 21 to the fixing unit 40. A surface of the print medium guide member 30 with which the print medium P is in contact may be bent so that the print medium P forms a curl or a loop. The print medium guide member 30 may be formed so that the print medium P forms the curl in a direction opposite to a direction in which the print medium P is curled as the print medium P passes through the transfer nip 21.

The fixing unit 40 is to fix the developer image onto the print medium P by applying heat and pressure to the print medium P on which the developer image is transferred, may comprise a heating roller 41 and a pressure roller 42.

The print medium supporting member 100 may be rotatably disposed between the transfer roller 20 and the print medium guide member 30, and supports the print medium P that comes out of the transfer roller 20 and moves to the fixing unit 40, thereby minimizing and/or preventing the rear end portion of the print medium P from being contaminated by the transfer roller 20.

For this, the print medium supporting member 100 includes a first contacting portion 101 to be in contact with a leading end of the print medium P that has passed through the transfer nip 21 and a second contacting portion 102 that, when the first contacting portion 101 is rotated around a rotation shaft 103 by the print medium P, is rotated integrally with the first contacting portion 101 so as to be in contact with a rear surface of the print medium P. In detail, the print medium supporting member 100 includes the first contacting portion 101 that makes first contact with the leading end of the print medium P having passed through the transfer nip 21 between the image carrier 11 and the transfer roller 20, and the second contacting portion 102 that contacts the rear surface of the print medium P as the print medium P passes the first contacting portion 101 when the first contacting portion 101 is rotated a predetermined angle by the print medium P after the leading end of the print medium P is in contact with the first contacting portion 101.

The print medium supporting member 100 may therefore include the rotation shaft 103, the first contacting portion 101, and the second contacting portion 102. The rotation shaft 103 may be rotatably disposed between the transfer roller 20 and the print medium guide member 30. The first contacting portion 101 may extend from the rotation shaft 103 toward the print medium guide member 30, and the second contacting portion 102 may extend from the rotation shaft 103 toward the transfer roller 20. When first contacting portion 101 receives a pressure by the contact with the print medium P, the pressure which the first contacting portion 101 receives is transmitted to the second contacting portion 102 through the rotation shaft 103 so that the second contacting portion 102 is rotated to support the rear surface of the print medium P.

Accordingly, the second contacting portion 102 is disposed adjacent to the transfer roller 20, and is formed so as to not contact the print medium P until the print medium P is in contact with the first contacting portion 101 in order that the second contacting portion 102 does not interfere with the leading end of the print medium P that is coming out of the transfer roller 20. Also, the second contacting portion 102 is formed so that, when the rear end portion of the print medium P leaves the transfer nip 21, the second contacting portion 102 supports the rear surface of the print medium P to block the rear end portion of the print medium P from impacting on the transfer roller 20.

The print medium supporting member 100 is disposed so that, when no force is applied to the print medium supporting member 100, that is, before the leading end of the print medium P is in contact with the first contacting portion 101 of the print medium supporting member 100, the first contacting portion 101 of the print medium supporting member 100 intersects a tangent line TL that passes through the transfer nip 21. The tangent line TL may be viewed as representing a path of the print medium P as it exits the transfer roller 20. The second contacting portion 102 of the print medium supporting member 100 is formed and disposed not to intersect the tangent line TL passing through the transfer nip 21. In other words, in a position where an external force is not applied to the print medium supporting member 100 (hereinafter, referred to as a first position), the first contacting portion 101 of the print medium supporting member 100 intersects a common tangent line TL of the image carrier 11 and the transfer roller 20 (namely, the tangent line passing through the transfer nip 21), and the second contacting portion 102 thereof is not disposed to intersect the common tangent line TL. When there is no print medium P, as illustrated in FIG. 2, a distal end 101a of the first contacting portion 101 projects over the common tangent line TL of the transfer roller 20 and the image carrier 11 toward the image carrier 11, and a distal end 102a of the second contacting portion 102 is placed below the common tangent line TL adjacent to the transfer roller 20. If the distal end 101a of the first contacting portion 101 receives a force due to the print medium P, the distal end 101a of the first contacting portion 101 is moved toward the print medium guide member 30, and the distal end 102a of the second contacting portion 102 is raised up.

Further, as the print medium P moves toward the fixing unit 40, the print medium supporting member 100 is rotated a certain angle on the rotation shaft 103 by the print medium P so that both the distal end 101a of the first contacting portion 101 and the distal end 102a of the second contacting portion 102 are brought into contact with the rear surface of the print medium P. Hereinafter, a position where both the distal end 101a of the first contacting portion 101 and the distal end 102a of the second contacting portion 102 are in contact with the print medium P is referred to as a second position. Accordingly, the print medium supporting member 100 may be moved between the first position and the second position by the print medium P.

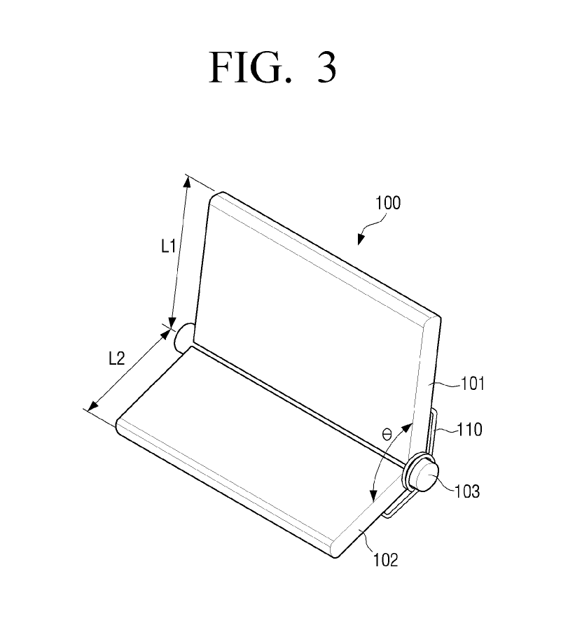

FIG. 3 illustrates a perspective view of an example of the print medium supporting member 100 that can be included in the image forming apparatus 1 according to an exemplary embodiment of the present general inventive concept.

Referring to FIG. 3, the print medium supporting member 100 may include the first contacting portion 101, the second contacting portion 102, and a restoring member 110. The first and second contacting portions 101 and 102 may be formed, for example, as rectangular plates extending from the rotation shaft 103 or as plates formed in another shape. The first and second contacting portions 102 are bent a predetermined angle θ on the rotation shaft 103 so that the first and second contacting portions 101 and 102 do not form a single plane. Further, the length L1 of the first contacting portion 101 may be formed to be longer than or the same as the length L2 of the second contacting portion 102. The length L1 of the first contacting portion 101, the length L2 of the second contacting portion 102, and the angle θ between the first and second contacting portions 101 and 102 may vary depending on the installation location of the print medium supporting member 100. Accordingly, the length L1 of the first contacting portion 101, the length L2 of the second contacting portion 102, and the angle θ between the first and second contacting portions 101 and 102 may be determined so that the leading end of the print medium P is in contact with the first contacting portion 101, and thus the print medium supporting member 100 is rotated so that the second contacting portion 102 is brought into contact with the rear surface of the print medium P.

The restoring member 110 is to restore the print medium supporting member 100 to its original position, and an elastic member may be used as the restoring member 110. In the present embodiment, a torsion spring that is disposed in the rotation shaft 103 is used as the restoring member 110. The restoring member 110 may be formed so that, when the print medium P is in contact with the first contacting portion 101, the print medium supporting member 100 is rotated, and, when the print medium P leaves the print medium supporting member 100, the print medium supporting member 100 is returned to the original position. Here, the original position of the print medium supporting member 100 means a state in which the external force is not applied to the print medium supporting member 100, that is, the first position as described above in which the print medium supporting member 100 is not in contact with the print medium P.

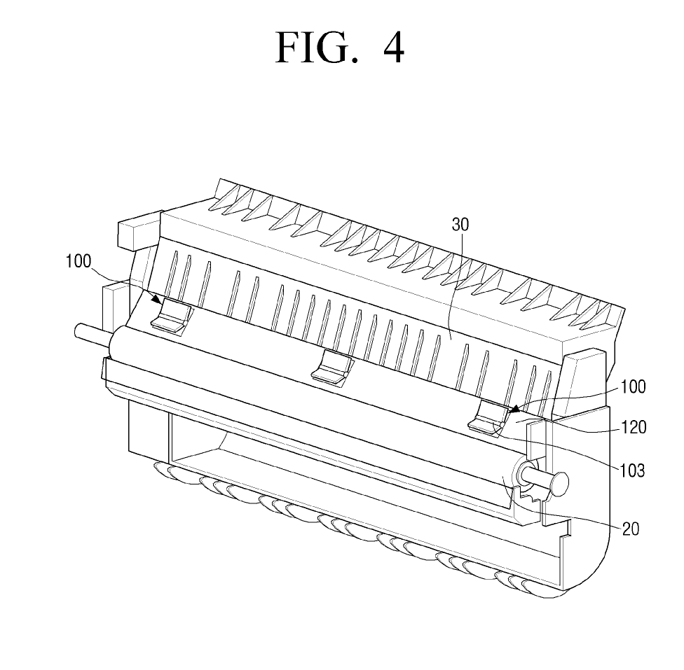

FIG. 4 illustrates a perspective view of the print medium supporting member 100 of FIG. 3 disposed between a transfer roller 20 and a print medium guide member 30.

As illustrated in FIG. 4, the image forming apparatus 1 according to the present exemplary embodiment uses three print medium supporting members 100. In order to stably support the print medium P that is discharged from the transfer roller 20 and is moved to the print medium guide member 30, at least two print medium supporting members 100 that are disposed at intervals may be used. In FIG. 4, three print medium supporting members 100 are rotatably disposed in a mounting bracket 120, and may support a left portion, a middle portion, and a right portion of the rear surface of the print medium P, respectively. The supporting members 100 may be positioned at intervals having a predetermined distance between each member. The supporting members 100 may further be aligned in a linear arrangement along a common line. Since the rotation shaft 103 of the print medium supporting member 100 is rotatably disposed in the mounting bracket 120, when the print medium P moves, the print medium supporting member 100 can be rotated with respect to the mounting bracket 120. Further, FIG. 4 illustrates a view in which the image carrier 11 is removed in order to show the installation state of the print medium supporting member 100.

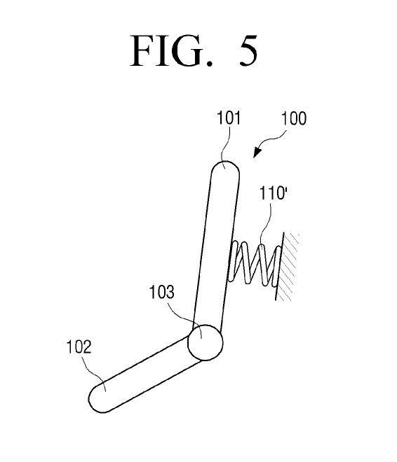

FIG. 5 illustrates a view of another print medium supporting member that is used in an image forming apparatus according to another exemplary embodiment of the present general inventive concept.

The print medium supporting member 100 as illustrated in FIG. 5 has the same structure as that of the print medium supporting member 100 as described above except for a restoring member 110′. A coil spring that is disposed on a rear surface of the first contacting portion 101 may be used as the restoring member 110′. The coil spring 110′ may be attached to the mounting bracket 120 illustrated in FIG. 4 or to another bracing structure within the image forming apparatus 1 such that it is disposed to press the first contacting portion 101 toward an original position, that is, a state in which an external force is not applied to the print medium supporting member 100. If the print medium P applies a pressure to the first contacting portion 101, the coil spring 110′ is compressed so that the first contacting portion 101 is rotated. As a result, both the first contacting portion 101 and the second contacting portion 102 support the rear surface of the print medium P. Also, if the print medium P leaves the first contacting portion 101, the coil spring 110′ presses the first contacting portion 101 to allow the print medium supporting member 100 to return to the original position. The structures and operations of the rotation shaft 103, the first contacting portion 101, and the second contacting portion 102 of the print medium supporting member 100 according to the present embodiment are the same as those of the print medium supporting member 100 as described above. Therefore, detailed descriptions thereof are omitted.

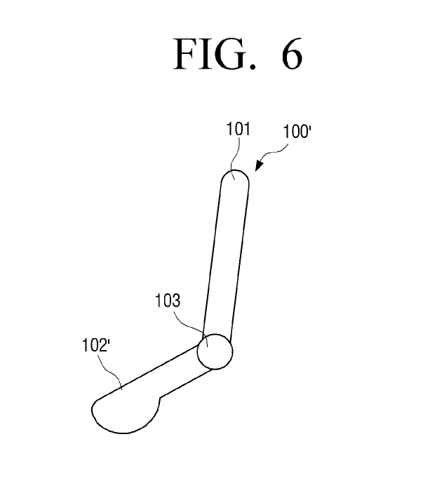

FIG. 6 illustrates a view of still another exemplary embodiment of a print medium supporting member that is used in an image forming apparatus according to an embodiment of the present general inventive concept.

Referring to FIG. 6, a print medium supporting member 100′ includes a rotation shaft 103, a first contacting portion 101, and a second contacting portion 102′. The second contacting portion 102′ is formed to have a weight heavier than the weight of the first contacting portion 101. Accordingly, when a pressure is not applied to the print medium supporting member 100′ by the print medium P, the print medium supporting member 100′ is placed at the first position as described above by gravity pulling the second contacting portion 102′. In this embodiment the force of gravity applied to the weighted second contacting portion 102′ supplies the force of the restoring member 110, therefore a separate restoring member 110 is not required. Otherwise, except for the weight of the second contacting portion 102′, the structures of the rotation shaft 103, the first contacting portion 101, and the second contacting portion 102′ of the print medium supporting member 100′ according to the present embodiment are the same as or similar to those of the print medium supporting member 100 as described above. Accordingly, if the print medium P applies a pressure to the first contacting portion 101, the print medium supporting member 100′ is rotated so that both the first contacting portion 101 and the second contacting portion 102′ are in contact with the rear surface of the print medium P, and, if the print medium P leaves the print medium supporting member 100′, the print medium supporting member 100′ is restored to the first position by gravity.

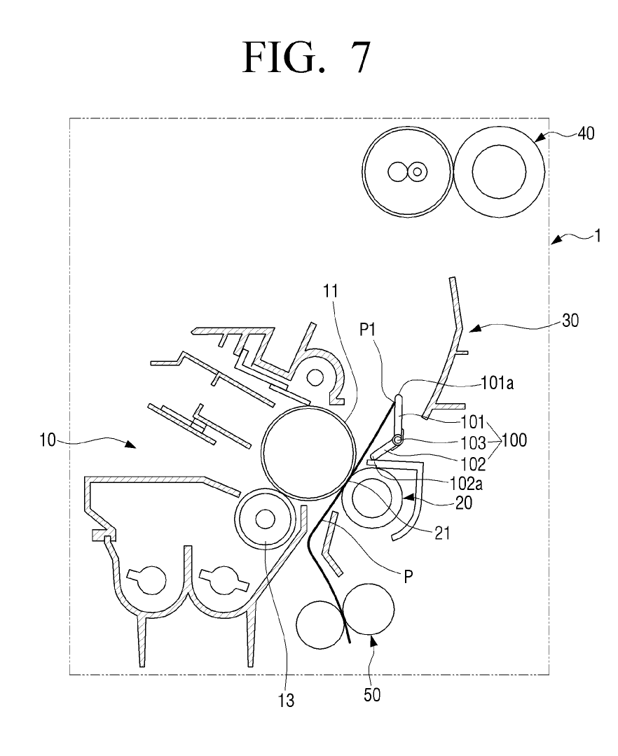

Hereinafter, an operation of an image forming apparatus 1 according to an embodiment of the present general inventive concept with the structure as described above will be described mainly on the action of the print medium supporting member 100 with reference to accompanying FIGS. 7, 8, and 9.

FIGS. 7, 8 and 9 illustrate an operation of a print medium supporting member in an image forming apparatus according to an embodiment of the present general inventive concept.

According to a print command of a controller (not illustrated), an exposure unit (not illustrated) forms an electrostatic latent image on a surface of the rotating image carrier 11, and the developing roller 13 supplies developer to the image carrier 11 to form the electrostatic latent image into a developer image. As the image carrier 11 is rotated, the developer image is placed in the transfer nip 21.

On the other hand, according to the print command of the controller, a pickup roller (not illustrated) of the print medium feeding unit (not illustrated) picks up the print media P one by one, and feeds the print medium P to the register roller 50. The register roller 50 feeds the print medium P to the transfer nip 21 at the timing when the developer image reaches the transfer nip 21. Then, the developer image on the image carrier 11 is transferred onto the print medium P by a transfer bias being applied to the transfer roller 20.

The print medium P onto which the transfer of the developer image is completed exits the transfer roller 20, and then moves toward the print medium guide member 30. Just before the leading end P1 of the print medium P that exits the transfer roller 20 is in contact with the first contacting portion 101 of the print medium supporting member 100, the print medium supporting member 100 keeps a state as illustrated in FIG. 7. At this time, the distal end 102a of the second contacting portion 102 is spaced apart so as to not to be in contact with the leading end P1 of the print medium P. When the leading end P1 of the print medium P reaches the first contacting portion 101, the second contacting portion 102 is positioned below the rear surface of the print medium P. Accordingly, the second contacting portion 102 does not interfere with the movement of the leading end P1 of the print medium P.

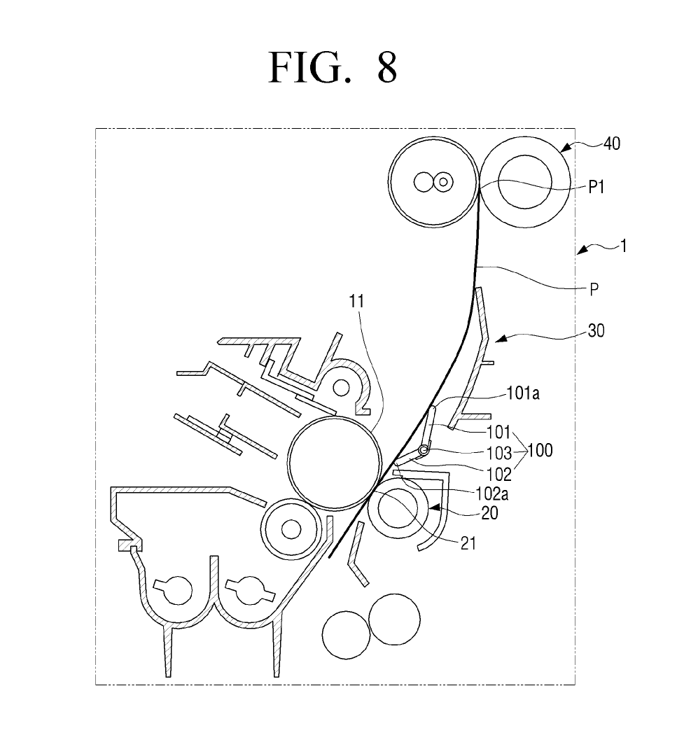

As the print medium P continues moving, as illustrated in FIG. 8, the leading end P1 of the print medium P passes the first contacting portion 101 of the print medium supporting member 100 and the print medium guide member 30 and reaches the fixing unit 40. At this time, the rear surface of the print medium P presses the first contacting portion 101 of the print medium supporting member 100 so that the first contacting portion 101 is rotated on the rotation shaft 103 toward the print medium guide member 30. If the first contacting portion 101 of the print medium supporting member 100 is rotated, the second contacting portion 102 also is rotated on the rotation shaft 103 to rise toward the tangent line TL (as illustrated in FIG. 2) of the transfer nip 21 so that the second contacting portion 102 is brought into contact with the rear surface of the print medium P that is passing the first contacting portion 101.

In detail, if the print medium P enters the fixing unit 40, the print medium P forms a curl. Depending on the amount of the curl of the print medium P, the pressure which the rear surface of the print medium P applies to the distal end 101a of the first contacting portion 101 of the print medium supporting member 100 is increased. The more the curl of the print medium P is increased, the more the pressure which the print medium P applies to the distal end 101a of the first contacting portion 101 is increased. If the pressure is further increased, the distal end 101a of the first contacting portion 101 is further rotated based on the rotation shaft 103 to be moved closer to the print medium guide member 30.

On the other hand, the second contacting portion 102 of the print medium supporting member 100 moves toward the moving print medium P on the rotation shaft 103 to support the rear surface of the print medium P in a space between the transfer roller 20 and the print medium guide member 30. At this time, a position of the distal end 102a of the second contacting portion 102 is determined by the position of the first contacting portion 101. If the curl of the print medium P is very large, both the distal end 101a of the first contacting portion 101 and the distal end 102a of the second contacting portion 102 of the print medium supporting member 100 are in contact with the print medium P so that the first contacting portion 101 and the second contacting portion 102 are moved to a position in which the equilibrium of forces which the print medium P applies to the first contacting portion 101 and the second contacting portion 102 takes place. In the present general inventive concept, in order to minimize and/or prevent the rear end portion of the print medium P from colliding with the transfer roller 20 due to the second contacting portion 102 that is pushed by the pressure of the print medium P that is applied to the distal end 102a of the second contacting portion 102, the length L2 of the second contacting portion 102 is formed to be shorter than or the same as the length L1 of the first contacting portion 101.

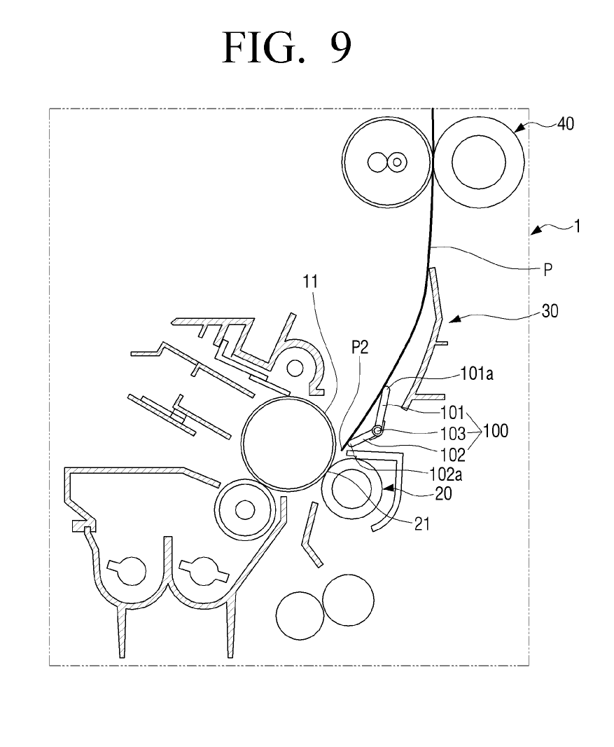

If the print medium P continues to move, as illustrated in FIG. 9, when the rear end P2 of the print medium P comes out of the transfer nip 21, the print medium supporting member 100 supports the print medium P to minimize and/or prevent the rear end P2 of the print medium P from moving toward the transfer roller 20. Therefore, contamination of the rear end portion of the print medium P is minimized and/or prevented.

In detail, when the rear end P2 of the print medium P comes out of the transfer nip 21, the print medium P that is curled in the transfer nip 21 tries to return to the original state by the restoring force of the print medium P so that the rear end P2 of the print medium P tries to move toward the transfer roller 20. However, since the distal end 102a of the second contacting portion 102 of the print medium supporting member 100 supports the rear surface of the print medium P at a position adjacent to the transfer roller 20, the rear end P2 of the print medium P cannot move toward the transfer roller 20. Accordingly, the print medium supporting member 100 according to an embodiment of the present general inventive concept may minimize and/or prevent contamination of the rear end portion of the print medium P. If the curl of the print medium P becomes larger so that the restoring force of the print medium P becomes larger, the pressure which the print medium P applies to the first contacting portion 101 of the print medium supporting member 100 is increased as the restoring force of the print medium P is increased. If the pressure applied to the first contacting portion 101 of the print medium supporting member 100 is increased, the force of the second contacting portion 102 that supports the print medium P also is increased, thereby minimizing and/or preventing the rear end P2 of the print medium P from being in contact with the transfer roller 20. If the rear end P2 of the print medium P completely comes out of the print medium supporting member 100, the print medium supporting member 100 is rotated by the restoring member 110, i.e. a torsion spring, which elastically supports the print medium supporting member 100, to return to the original position, that is, the first position.

As described above, in a case of the image forming apparatus 1 according to an embodiment of the present general inventive concept, since the print medium supporting member 100 disposed between the transfer roller 20 and the print medium guide member 30 supports the print medium P that has passed through the transfer nip 21, thereby minimizing and/or preventing the rear end P2 of the print medium P from colliding with the transfer roller 20, contamination of the rear end portion of the print medium P that is generated by collision of the rear end P2 of the print medium P having passed through the transfer nip 21 with the transfer roller 20 may be minimized and/or prevented.

Also, since the image forming apparatus 1 according to an embodiment of the present general inventive concept as described above can minimize and/or prevent the contamination of the rear end portion of the print medium P by using only the print medium supporting member 100 of a simple structure, the manufacturing cost may be reduced in comparison with conventional methods of minimizing and/or preventing contamination of the rear end portion of the print medium P.

In the above description, the case in which a photosensitive medium, i.e., a photosensitive drum is used as the image carrier 11 is described as an example, but even when an intermediate transfer member is used as the image carrier 11, contamination of the rear end portion of the print medium P may be prevented by using the print medium supporting member 100 as described above.

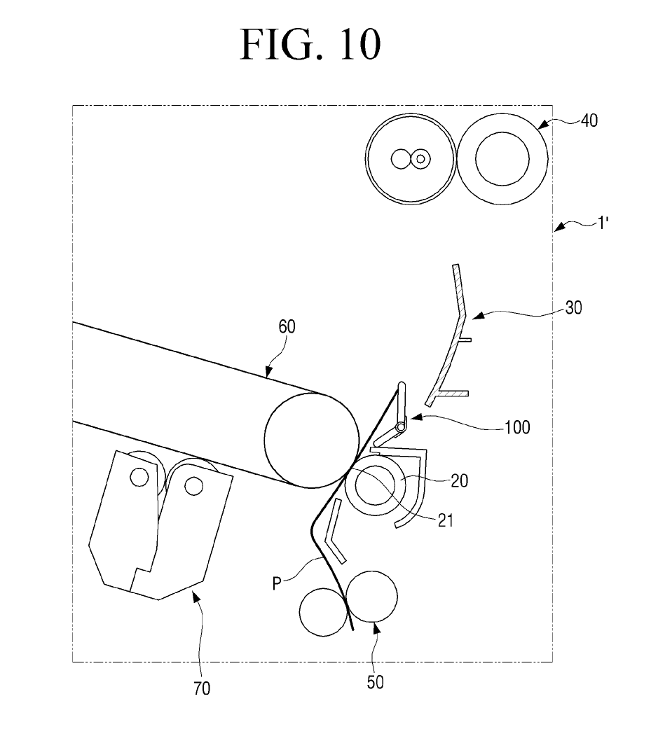

FIG. 10 illustrates a partial cross-sectional view of an image forming portion of an image forming apparatus that uses an intermediate transfer member.

Referring to FIG. 10, an image forming apparatus 1′ uses an intermediate transfer belt as an intermediate transfer member 60. An image forming unit 70 to transfer a developer image onto the intermediate transfer member 60 is disposed in a side of the intermediate transfer member 60. The intermediate transfer member 60 is in contact with the transfer roller 20 to form a transfer nip 21. Accordingly, the developer image on the intermediate transfer member 60 is transferred onto the print medium P passing between the intermediate transfer member 60 and the transfer roller 20. The print medium P that has passed the transfer roller 20 is supported by the print medium supporting member 100 according to an embodiment of the present general inventive concept so that contamination of the rear end portion of the print medium P may be minimized and/or prevented.

The image forming apparatus 1′ according to the present embodiment is the same as the image forming apparatus 1 as described above except for using the intermediate transfer member 60 to transfer the developer image formed in the image forming unit 70 onto the print medium P. Therefore, a detailed description thereof is omitted.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
an image carrier on which a developer image is formed;
a transfer roller disposed to be in contact with the image carrier to form a transfer nip and to transfer the developer image formed on the image carrier onto a print medium;
a print medium guide member to guide the print medium that has passed through the transfer nip to a fixing unit; and
a print medium supporting member rotatably disposed between the transfer roller and the print medium guide member, and comprising a first contacting portion to be in contact with the print medium that has passed through the transfer nip and a second contacting portion that, when the first contacting portion is rotated by the print medium, is rotated integrally with the first contacting portion so as to be in contact with a rear surface of the print medium.

2. The image forming apparatus of claim 1, wherein
the print medium supporting member further comprises a rotation shaft that is rotatably disposed between the transfer roller and the print medium guide member,
the first contacting portion extends from the rotation shaft toward the print medium guide member,
the second contacting portion extends from the rotation shaft toward the transfer roller, and
the second contacting portion is disposed so as to not be in contact with the print medium until the print medium is in contact with the first contacting portion.

3. The image forming apparatus of claim 2, wherein the first contacting portion of the print medium supporting member intersects a tangent line passing through the transfer nip before the print medium is in contact with the first contacting portion of the print medium supporting member.

4. The image forming apparatus of claim 3, wherein the second contacting portion of the print medium does not intersect the tangent line passing through the transfer nip.

5. The image forming apparatus of claim 1, wherein the print medium supporting member is disposed to move between a first position in which both the first contacting portion and the second contacting portion are not in contact with the print medium and a second position in which both the first contacting portion and the second contacting portion are in contact with the print medium.

6. The image forming apparatus of claim 5, wherein, when the print medium is not in contact with the print medium supporting member, the print medium supporting member is placed in the first position.

7. The image forming apparatus of claim 6, wherein the print medium supporting member further comprises:
a restoring member to return the print medium supporting member to the first position.

8. The image forming apparatus of claim 7, wherein the restoring member comprises a coil spring or a torsion spring.

9. The image forming apparatus of claim 7, wherein the print medium supporting member is formed so that a weight of the second contacting portion is heavier than a weight of the first contacting portion, and the print medium supporting member is returned to the first position by gravity.

10. The image forming apparatus of claim 1, wherein the print medium supporting member comprises:
at least two print medium supporting members.

11. The image forming apparatus of claim 1, wherein the image carrier is a photosensitive member.

12. The image forming apparatus of claim 1, wherein the image carrier is an intermediate transfer member.

13. An image forming apparatus comprising:
an image carrier on which a developer image is formed;
a transfer roller disposed to be in contact with the image carrier to form a transfer nip and to transfer the developer image formed on the image carrier onto a print medium;
a print medium guide member to guide the print medium that has passed through the transfer nip to a fixing unit; and
a print medium supporting member disposed between the transfer roller and the print medium guide member, and to rotate between a first position and a second position,
wherein the print medium supporting member comprises a rotation shaft rotatably disposed between the transfer roller and the print medium guide member, a first contacting portion extending from the rotation shaft toward the print medium guide member, and a second contacting portion extending from the rotation shaft toward the transfer roller,
wherein when the print medium supporting member is placed in the first position, the first contacting portion intersects a tangent line of the transfer nip, and the second contacting portion does not intersect the tangent line of the transfer nip, and,
wherein when the print medium supporting member is placed in the second position, the first contacting portion and the second contacting portion are in contact with the print medium.

14. The image forming apparatus of claim 13, wherein a leading end of the print medium that has passed through the transfer nip is in contact with the first contacting portion of the print medium supporting member that is placed in the first position, and, as the print medium continues to move, the first contacting portion is rotated so that the first contacting portion is in contact with the rear surface of the print medium and then the second contacting portion is in contact with the rear surface of the print medium.

15. The image forming apparatus of claim 13, wherein the first and second contacting portions are formed in a rectangular plate, and a length of the first contacting portion is longer than or a same length as a length of the second contacting portion.

16. The image forming apparatus of claim 13, wherein the second contacting portion is positioned so as to not contact the print medium until the print medium is in contact with the first contacting portion.
